(19) United States
(12) Patent Application Publication
(10) Pub. No.: US 2005/0114680 A1
(43) Pub. Date: May 26, 2005

(54) Method and system for providing SIM-based roaming over existing WLAN public access infrastructure

(75) Inventors: Sudhagar Chinnaswamy, Sunnyvale, CA (US); Nishi Kant, San Jose, CA (US); Mike Ritter, Los Altos, CA (US)

Correspondence Address: RAE-VENTER LAW GROUP, P.C., P.O. BOX 1898, MONTEREY, CA, 93942-1898, US

(73) Assignee: Azaire Networks Inc. (a Delaware corporation), Santa Clara, CA (US)

(21) Appl. No.: 10/836,702

(22) Filed: Apr. 29, 2004

Related U.S. Application Data
(60) Provisional application No. 60/466,840, filed on Apr. 29, 2003.

(51) Int. Cl. H04K 1/00; H04L 9/00; H04L 9/32; G06F 12/14; G06F 11/30

(52) U.S. Cl. 713/185

(57) ABSTRACT

A method and apparatus for performing SIM-based authentication and authorization in a WLAN Internet Service Provider (WISP) network supporting the universal access method (UAM) of authentication and authorization enabling roaming for customers of mobile service providers onto said networks. In addition, the invention provides a secure way of authenticating the customer's client device to the mobile service provider's network by employing temporary credentials for authentication that provide privacy of the user's identity and prevent replay attacks. Finally, if the WISP network supports the ‘pass-through’ facility, the authentication can be done more securely and quickly.

### CROSS-REFERENCE TO RELATED APPLICATION

This application claims benefit of priority to U.S. Ser. No. 60/466,840, filed Apr. 29, 2003, the disclosure of which is incorporated herein by reference.

### INTRODUCTION

1. Technical Field

This invention relates to a method and apparatus for performing SIM-based authentication and authorization in a WLAN Internet Service Provider (WISP) network supporting the universal access method (UAM ) of authentication and authorization enabling roaming for customers of mobile service providers onto said networks without any modifications to said networks.

2. Background of the Invention

Authentication and authorization of customers of mobile service providers (cellular telecommunications carriers) in wireless local area network (WLAN) deployments, typically occurs in areas called “hotspots.” These hotspots are deployed at retail outlets, such as restaurants, coffee shops, print shops or bookstores, or at large public venues, such as airports, hotels and convention centers to provide customers with value-added services such as Internet connectivity, virtual private networks (VPN), e-mail and local printing services. Because of the diverse nature of these deployments, the ownership of the hotspots is spread among many entities, and no single entity controls a majority of the hotspots. Entities with large bases of customers would like to leverage these assets and increase revenue by providing the billing services for their customers for the hotspot owners. Thus there is a need to allow for roaming between the various hotspots in a similar manner to cellular telephone service roaming between mobile service providers. This means that there is a need for a customer from one entity to be authenticated, authorized and billed for use of a network owned by a separate entity.

There are various methods for supporting roaming. The most popular method can be described as ‘browser hijacking’ or the ‘universal access method.’ It relies upon the customer having a client device that has a web browser. When the client device connects to the WLAN and attempts to launch the web browser, the WLAN ‘captures’ the packets locally and responds with a logon page that appears on the client device. The logon page allows the customer to enter their username and password into fields present on said page and submits them to the WLAN. For roaming, the username field is overloaded to include the domain name of the customer's service provider so the WLAN infrastructure can determine where to forward the credentials (username and password) to authenticate the user. Typically, this is done by inserting the fully qualified domain name of the customers service provider following the username and separated from it by an ‘@’ sign; e.g., the username field would contain Tom@company.com, where Tom is the username and company.com is the fully qualified domain name of Tom's service provider. This can all be automated by a smart client residing on the customer's device and be transparent to the user. The WLAN infrastructure takes the credentials, forwards them to the authentication, authorization and accounting (AAA) server designated in the domain name, typically using the well-known RADIUS protocol, and receives a reply that either accepts or rejects the user as a an authenticated and authorized user.

This first method is relatively insecure and can lead to service fraud and service theft at the hotspots. It is analogous to the first system used to authenticate and authorize cellular phones by mobile service providers. These service providers have employed the subscriber identity module (SIM) model to address the problems that arise in a username and password based authentication system, such as cloning or stealing credentials or the difficulty of transferring the credentials to a new device. In the SIM model, a SIM card holds the credentials securely and cannot be easily cloned or stolen and is simple to move to a new device. Thus there is a need to make SIM-based authentication available to the customer.

A proposed method for allowing SIM-based authentication and authorization over a WLAN is to use the well-known Institute of Electrical and Electronic Engineering (IEEE) 802.1x framework with the well-known Internet Engineering Task Force (IETF) extensible authentication protocol (EAP.) This method allows one to use many additional methods of authentication beyond username and passwords, like smart cards, such as secure identity modules (SIM) used by mobile service providers. However, these protocols are still in flux, require new upgrades to all parts of the networking system, including the client device, the WLAN and the AAA servers; have very complicated backwards compatibility methods and are thus being deployed very slowly, if at all in public WLAN systems, being mostly relegated to enterprise solutions where one entity controls all of the aforementioned items.

Therefore there is a need to provide SIM-based authentication over the existing UAM supporting WLAN networks so that mobile service operators can deploy their roaming service today without waiting for networks and clients to be upgraded to support these new protocols.

### SUMMARY OF THE INVENTION

According to the invention, a method and apparatus perform SIM-based authentication and authorization in a WLAN Internet Service Provider (WISP) network supporting the universal access method (UAM) of authentication and authorization. Thus roaming is enabled for customers of mobile service providers onto the networks. In addition, the invention provides a secure way of authenticating the customer's client device to the mobile service provider's network by employing temporary credentials for authentication that provide privacy of the user's identity and prevents replay attacks.

This invention involves two levels of authentication. The first authentication is based on a SIM-based mutual authentication performed against the radio access controller (RAC) which is connected to the mobile service provider's authentication databases, typically a home location register (HLR.) Upon successful SIM-based authentication, an additional UAM authentication requiring a username and password is performed where these credentials are derived from said first authentication. The SIM authentication phase requires the WLAN to allow packets to flow between customer's client device and the RAC before the customer is authenticated and is transparent to the WLAN. Typically the control of packet routing between the WLAN and the outside world is performed by a public access controller (PAC) functionality that can reside in a WLAN access point (AP) or in a separate box. The functionality of the PAC typically includes this ability to designate particular outside entities, such as the RAC, to have packets directed to them before authentication of the client device. This is called “Pass-through”, “Firewall Filtering”, “White List”, or “Free Garden Services” and is extant in all known PACs.

Upon successful completion of the SIM-based authentication between the RAC and the client device over the aforementioned feature, the RAC and software on the client device generate a temporary set of credentials including a one-time username, designated tempID, and a password, using a session key obtained during the mutual authentication. The RAC stores the username and password in its database for verification of subsequent authentication of the client using the UAM. The client uses the tempID received from the RAC to construct an NAI (Network Access Identifier) in the form tempId@realm, where “realm” is a fully qualified domain name of the customer's mobile service provider's RAC. This can be placed in the username field of the browser logon page along with the generated password for authentication using the UAM. The PAC forwards the client's credentials to the RAC designated by the realm using the RADIUS protocol or some similar authentication protocol such as diameter. If the user is valid (has performed SIM authentication and the one-time credentials are valid), then access to network is granted; else the access to the network is denied. Accounting records are generated at the PAC and forwarded to the RAC designated by the realm, where the RAC converts them into call detail record (CDR) format and sends them to CGF.

If the “Pass-through” feature is not available or configured correctly on the PAC, the software on the client device attempts to authenticate itself using a three-level authentication scheme and uses a generated username and password which identifies the client as a likely customer by producing a signature of the MSISDN and IMSI of the client's SIM device for use via the UAM to get pre-authenticated to the PAC for a limited amount of time. During this time, the client performs the same SIM authentication as mentioned above. When the defined amount of time has passed, the PAC denies further access to the client.

The client, knowing the length of time during which it was authenticated in the pre-authentication stage can, when that time expires, automatically reauthenticate itself using the tempID and one-time password generated during the aforementioned SIM authentication using the UAM again and gain access to the services of the WLAN. In this manner, a customer of a mobile service provider can roam onto any existing Hotspot WLAN deployment that supports the UAM and get authenticated and authorized using their SIM card, without any modifications to the Hotspot.

The invention will be explained with reference to specific embodiments in reference to the following drawings.

### BRIEF DESCRIPTION OF THE DRAWINGS

FIG. 1 is a flow chart delineating some of the steps in one embodiment of the present invention.

FIG. 2 is a flow chart delineating some more of the steps in one embodiment of the present invention.

FIG. 3 is a flow chart delineating some more of the steps in one embodiment of the present invention

FIG. 4 is a flow chart delineating some more of the steps in one embodiment of the present invention.

FIG. 5 is a system block diagram of all the elements in a typical WLAN hotspot deployment and in a mobile service provider's network necessary for roaming.

FIG. 6 is a message flow/signaling chart showing all of the apparatus and the protocol messages that they exchange with each other to use the “IP pass-thru” method of SIM authentication on an existing WLAN Hotspot.

FIG. 7 is a message flow/signaling chart showing details of the protocol messages exchanged between the client and the RAC for SIM authentication

FIG. 8 is a message flow/signaling chart showing all of the apparatus and the protocol messages that they exchange for SIM-based authentication when the “IP pass thru” method is unavailable.

### DESCRIPTION OF SPECIFIC EMBODIMENTS OF THE INVENTION

This invention relates to a method and apparatus for performing SIM-based authentication and authorization in a WLAN Internet Service Provider (WISP) network supporting the universal access method (UAM) of authentication and authorization enabling roaming for customers of mobile service providers onto said networks without any modifications to said networks. An advantage of the invention is that it provides a secure way of authenticating a customer's client device to the mobile service provider's network by employing temporary credentials for authentication that provide privacy of the user's identity and prevent replay attacks. An additional advantage is that if the WISP network supports the “pass-through” facility, the authentication can be done more securely and quickly.

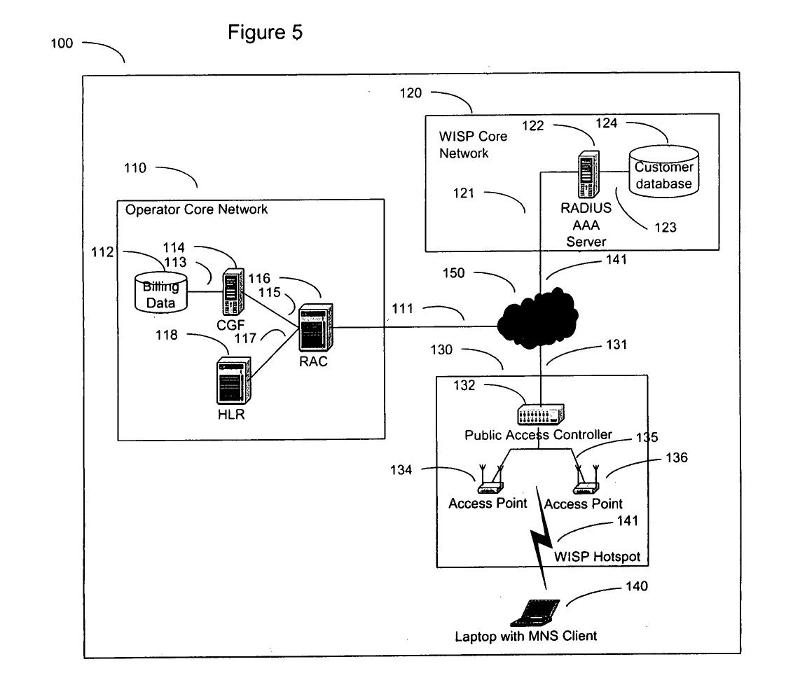

FIG. 5 is a block diagram of a system 100 according to the invention with the various elements required in a specific embodiment of said invention. The specific embodiment is suitable for the implementation of SIM-based authentication in WISP hotspots without any modification to said hotspots. The Operator Core Network 110 has a RAC 116 connected to a packet data network such as the Internet 150 via network connection 111 or directly connected to the WISP Hotspot; a home location register (HLR 118) connected to the RAC 116 typically over an SS7 connection 117; a charging gateway function (CGF 116) connected to the RAC 116 over a network connection 115 which in turn is connected to a billing database 112 over a network connection 113.

The WISP Hotspot has a Public Access Controller (PAC 132) also known as a Network Access Server (NAS) or a Radio Link Manager (RLM) connected to a packet data network such as the Internet 150 over network connection 131 or directly to the operator core network 110 and the WISP core network 120; also connected to WLAN Access Points (AP 134, 136) via network connection 135, typically Ethernet, but may be some such connection as DSL or some other bridged or routed network connection.

The WISP core network 120 has a AAA server 122, typically based on RADIUS and connected to a packet data network such as the Internet 150 over connection 121 or directly connected to the WISP hotspot 130 and the Operator Core Network 110; and also connected to the customer database 124 over connection 123. The client device 140 which may be a laptop, PDA, handset, or other computing device with WLAN connection 141 and SIM reading functionality (not shown) with client software (not shown) to provide for the invention's functionality.

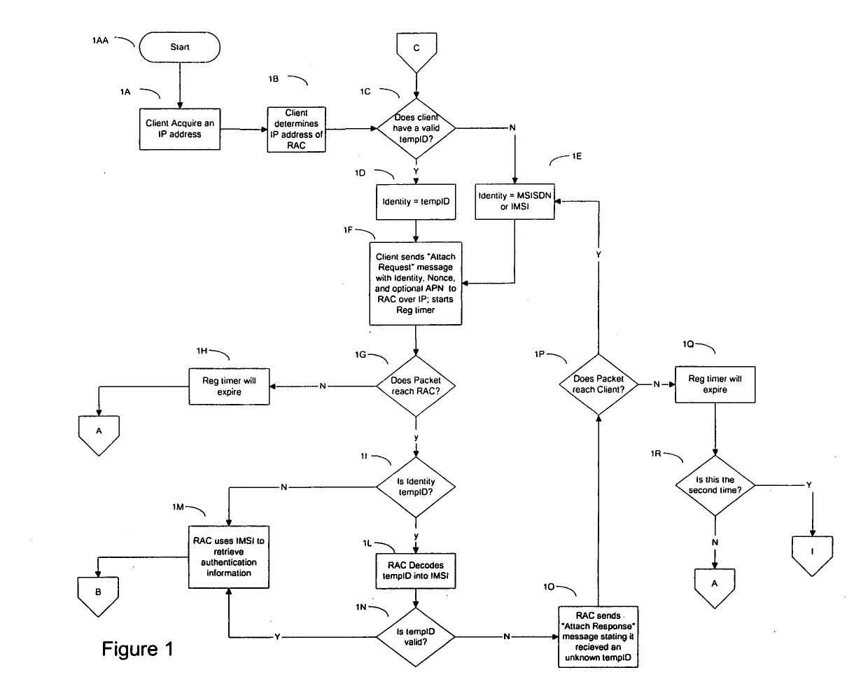

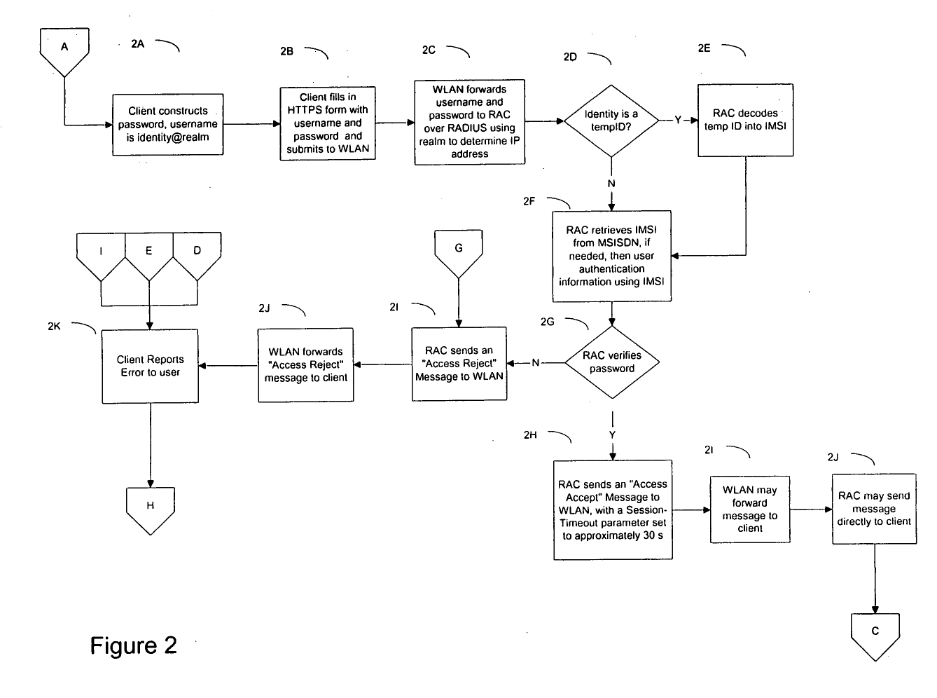

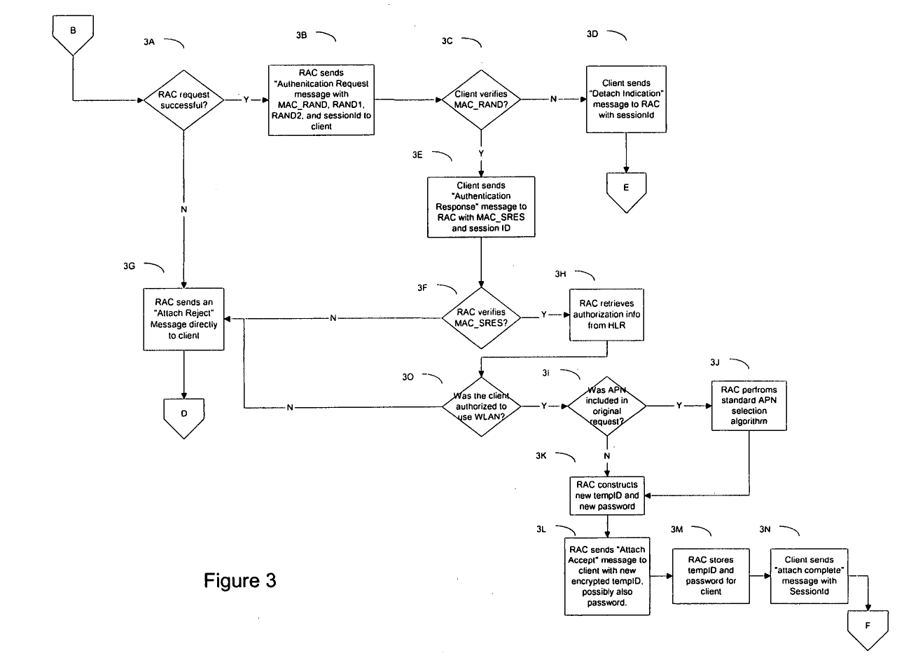

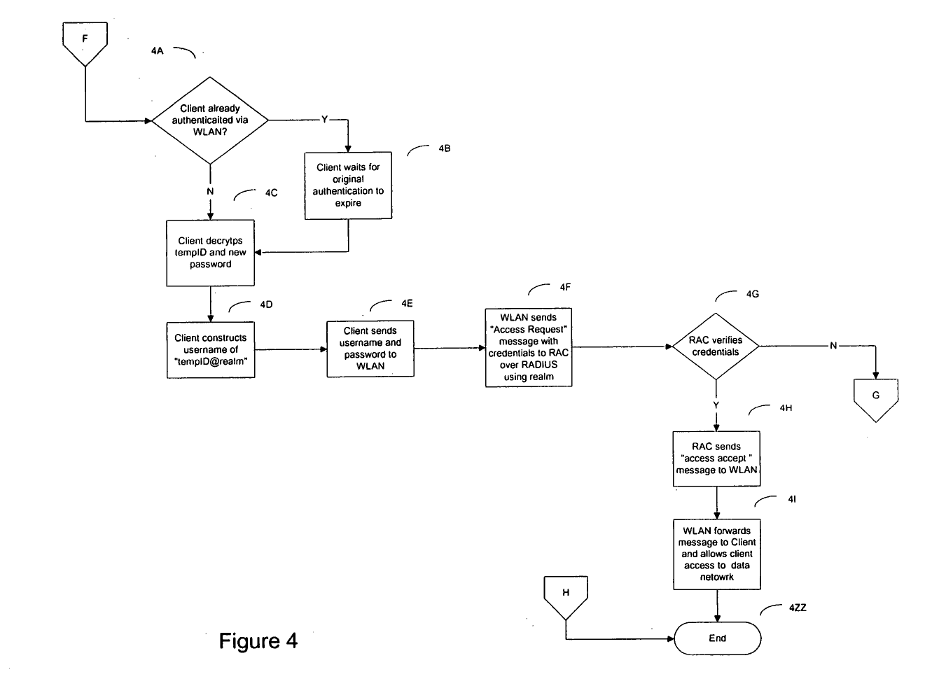

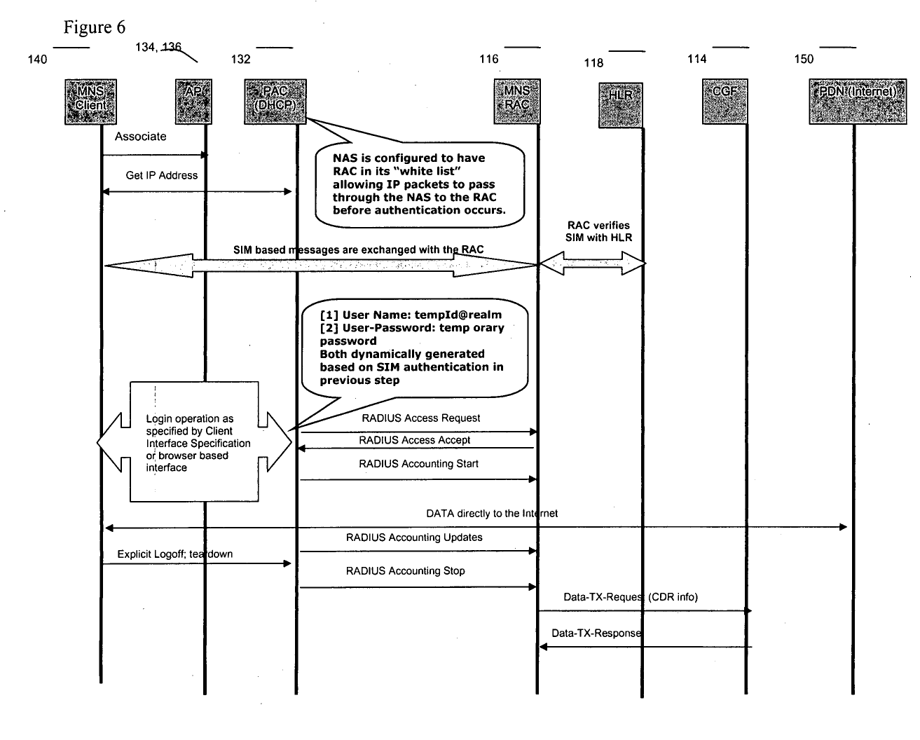

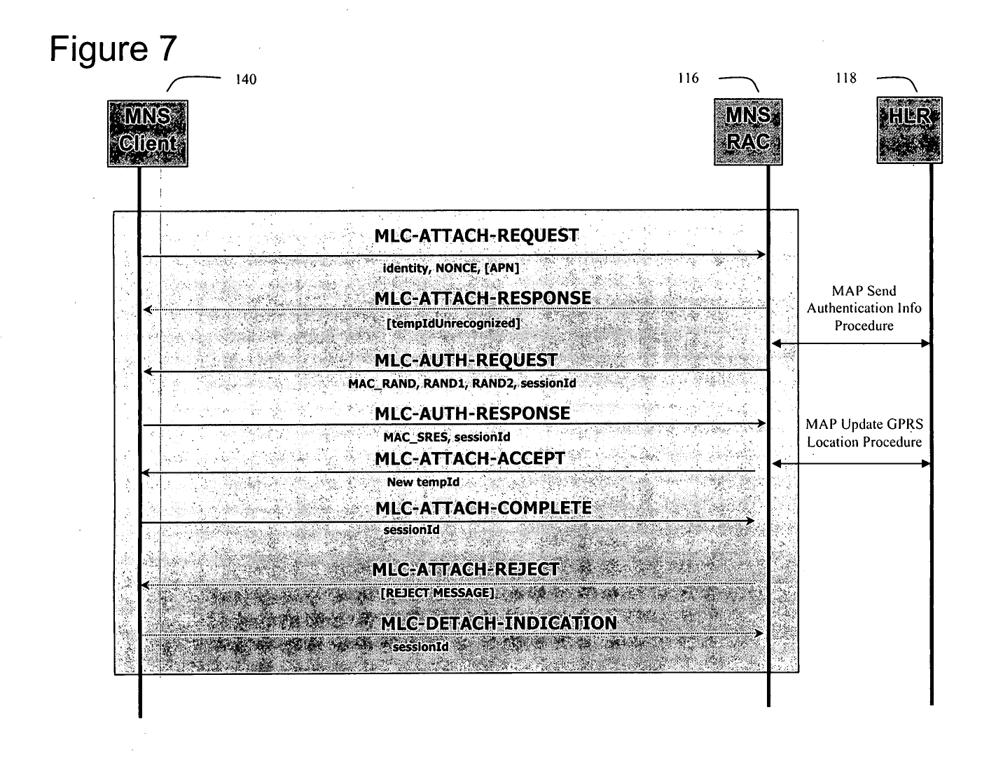

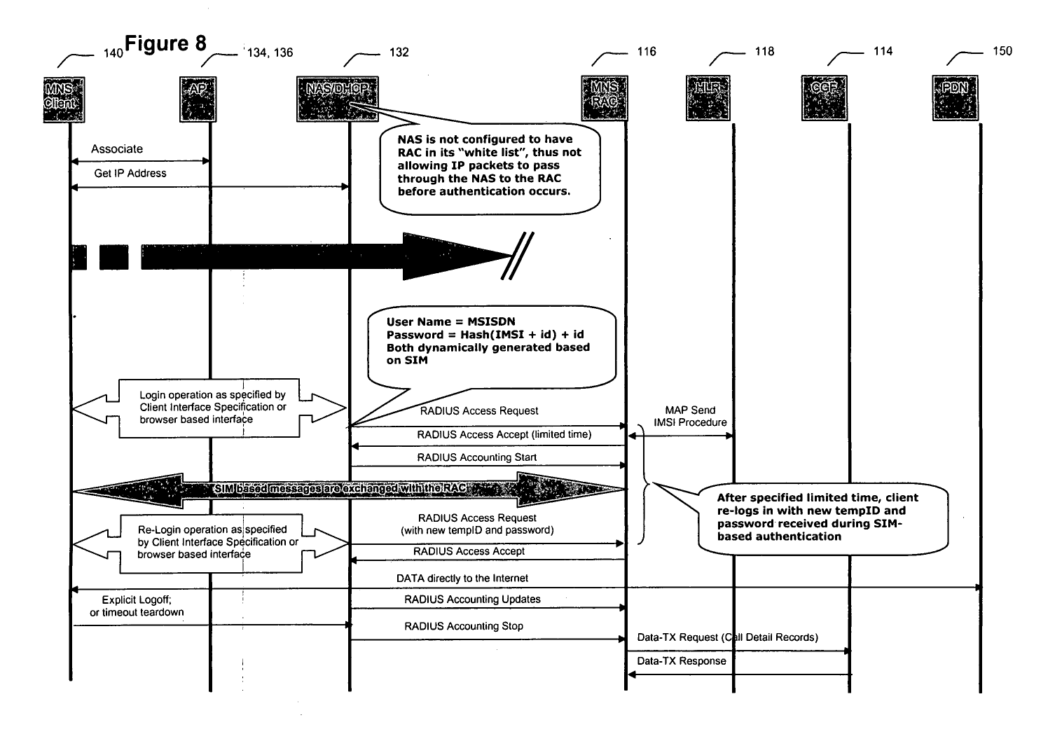

Message flows are shown in FIGS. 6, 7, and 8. FIGS. 1, 2, 3, and 4 show a flow chart of the procedures for RADIUS-SIM Authentication whether the PAC has “IP-pass through” capabilities or not. The entire procedure begins when a client device 140 comes in range of WLAN access points 134, 136 in a WISP hotspot 130. The customer launches the client software (not shown) and picks an AP 134, 136 to associate with. The client device 140 associates with the WLAN AP 134, 136 and acquires an IP address, typically by using DHCP or having it pre-configured (Step 1A).

The Client software (not shown) determines the IP address of the RAC, either using a well-known name lookup protocol such as the well-known DNS protocol or has the IP address pre-configured into the software (Step 1B).

The Client then reviews its configuration to see if it has what it thinks is a valid tempID (temporary identification) that it can use, if it does have one it sets its identity to the tempID (Step 1D), otherwise it sets its identity to the MSISDN of the SIM or its IMSI (Step 1E).

The Client 140 attempts to send an “attach request” message to the RAC and starts a Registration timer (Step 1F). The “attach request” message has at least the identity of the client, a nonce or random number and an optional Access Point Name (APN) that designates a network connection point in a GGSN (General Packet Radio Service Gateway Serving Node).

If the RAC receives the packet (Step 1G) it checks to see if the identity received was the tempID (Step 11), if the RAC 116 does not receive the packet, it sends no response back to the client and eventually the Registration timer expires and the client 140 realizes that it must first open up a network connection through the PAC 132 to reach the RAC 116. In order to do this, the client 140 creates a password and typically uses MSISDN as their identity, but may use IMSI. (Step 2A).

Next the username is constructed from the specific identity as identity@realm, where “realm” is the fully qualified domain name of the RAC 116, and the password is a digital signature of at least the IMSI and a random number concatenated with the random number. The client 140 requests a web page, typically using HTTPS that is redirected to a login page by the PAC 132.

The client 140 fills in the login page with these credentials (username and password) and forwards it back to the PAC 132 (Step 2B). The PAC 132 parses the username and password from the submitted web page and forwards the credentials to the RAC 116 as determined by the realm. The PAC 132 may also forward all authentication requests to the AAA Server 122 that would then use the realm to figure out how to forward it to the RAC 116 (Step 2C).

The RAC 116 determines if the identity in the username is a tempID (step 2D), if it is, the RAC decodes it and determines the IMSI from the tempID (Step 2E). The tempID can be constructed from a random number concatenated with the IMSI and encrypted with a secret key that only the RAC 116 knows. There are other methods for creating tempIDs that encode the IMSI as may be evident to one skilled in the art and some are discussed below.

If the identity is the IMSI, this may be used directly, if the identity is the MSISDN, the RAC 116 must retrieve the IMSI from the HLR 118 using the MAP procedure Send-IMSI (Step 2F). The RAC 116, having the IMSI at this point, can then determine if the digital signature in the password is correct (Step 2G). If the password is incorrect the RAC 116 sends an “Access reject” message to the PAC 132 (Step 2I), which it forwards to the client (Step 2J). The client may report this error to the user (Step 2K) and the procedure would end at this point.

If the password is correct the RAC 116 sends an “Access accept” message to the PAC 132 with at least the “Session Timeout” parameter set to about 30 seconds (Step 2H). At this point the client 140 may receive a message from the PAC 132 telling the client 140 that it is authorized to access the Internet 150 (Step 2I) and/or may receive a message directly from the RAC 116 telling it that it has been authorized to access the Internet (Step 2J).

At this point the client 140 checks to see if thinks it has a valid tempID again (Step 1C). The client continues through the flow chart as before and sends the “attach request” message to the RAC 116 and restarts its registration timer (Step 1F). At this point, the packet will reach the RAC 116 as the PAC 132 has granted access to the Internet for the client 140 and the RAC 116 will check if the identity is a tempID (Step 1I).

If the identity is a tempID the RAC 116 decodes it to get the IMSI (Step 1L). If not the RAC 116 can use either the IMSI directly, if that was sent or can use the MSISDN to retrieve the IMSI from the HLR 118. The Client 140 can then use the IMSI to retrieve the authentication information from the HLR 118. (Step 1M) The authentication information has at least one GSM (Global System for Mobile Communication) ‘triplet’ credential which is a random number RAND, a shared key Kc and a signed response SRES, the latter both generated from the shared key Ki (in both the SIM (not shown) in the client and the HLR 118 and the RAND so that they are unique for each authentication attempt.

If the tempID is invalid (Step 1N) the RAC 116 sends the “attach response” message to the client 140 stating it received an unknown temp ID (Step 1O). If the packet doesn't reach the client (Step 1P) the Registration timer will expire (Step 1Q) and if this is the second time the registration timer expired (Step 1R) the client 140 may report an error to the customer and the procedure ends. If this is the first time the registration timer expires the client 140 goes back to step 2A and continues through the flow chart to get to back Step 1C with an open connection to the RAC 116 and tries again.

If the packet reaches the client 140 and informs it that it has an unknown tempID, the client sets its identity to its MSISDN or IMSI (Step 1E) and sends a new “attach request” message. At this point the message will reach the RAC 116 and will be processed through steps 1G, 1I and 1M to retrieve at least one GSM ‘triplet’.

If the RAC 116 doesn't receive the GSM ‘triplet’ (Step 3A) it sends an “attach reject” message to the client (Step 3G) that may report an error to the customer (Step 2K) and the process terminates.

If the RAC 116 receives at least one GSM ‘triplet’ it sends an “authentication request” message to the client (Step 3B). The message contains the MAC_RAND and at least one random number (preferably two to increase the key entropy) RAND from a triplet and a session identifier which is a unique identifier for this transaction. The MAC_RAND is a digital signature that includes the RAND and at least one other element from the triplet credential that proves that it knows the shared key Ki.

If the client 140 cannot verify the MAC_RAND (Step 3C) it may send a “detach indication” message to the RAC 116 (Step 3D) and then an error message to the user (Step 2K) and the procedure terminates.

If the client 140 does verify the MAC_RAND (Step 3C) it sends an “authentication response” message to the RAC 116 (Step 3E). The message contains a session id and a MAC_SRES that has a signature of at least the RAND and the SRES that the client 140 received from the RAC 116 that proves that the client 140 also knows the shared key Ki and hence possesses the SIM.

If the RAC 116 cannot verify the MAC_SRES (Step 3F) it sends an “attach reject” message to the client (Step 3G) and proceeds as before to terminate the procedure.

If the RAC 116 verifies the MAC_SRES (Step 3F) it retrieves the authentication information from the HLR 118 (Step 3H). This information determines if the client 140 is able to use the WLAN service. If the client 140 is not authorized to use WLAN it proceeds to step 3G and to terminate the procedure as before.

If the client 140 was authorized to use the WLAN, the RAC 116 checks to see if there was an APN included in the original request (Step 31). If so, the RAC 116 performs the standard APN selection algorithm (Step 3J). Regardless, then the RAC 116 constructs a new tempID and a new password (Step 3K).

The RAC 116 sends the new tempID, and possibly a password, all typically encrypoted with the session key Kc, to the client (Step 3L). Alternatively, the password can be constructed on both sides as discussed below. The RAC 116 stores the new tempID and password for the client (step 3M). The client sends back an “attach complete” message with the sessionId included to the RAC (Step 3N).

The client 140 checks to see if it is already authorized to use the WLAN connection for a short period of time (the 30 seconds) (Step 4A), if so it waits for this time to expire (Step 4B), if not, it proceeds directly to decrypt the encrypted tempID received to get the new tempID and creates the new password (Step 4C).

The Client 140 then constructs a username of “‘new tempID’@realm” where realm is the fully qualified domain name of the RAC 116 (Step 4D).

The Client 140 requests the PAC 132 to send it the ‘login’ page and fills in the generated credentials and sends the page to the PAC 132 (Step 4E). The PAC 132 parses the web page and sends the credentials to the RAC 116 as designated by the realm, typically using RADIUS (Step 4F).

The RAC 116 checks the credentials (Step 4G) if it cannot verify them, the RAC 116 proceeds to step 2L and continues through the flow chart to terminate the procedure as before. If the RAC 116 can verify the credentials, the RAC 116 sends an “Access accept” message to the PAC 132 (Step 4H).

The PAC 132 may forward a message to the client 140 telling it that it has access to the packet data network 150 and allows packets from the client 140 to flow to the packet data network 150 (step 4L). The procedure is then finished.

More details on the SIM authentication procedure and the password generating procedure are described below.

SIM Authentication Procedure

User/Client enters the WLAN coverage area of the Access Point in WISP network and gets associated.

The user equipment (Laptop/PDA) receives IP address possibly from Access gateway such as PAC/NAS/MNS-RLM using DHCP or some other method. The access gateway is configured with RAC IP address in its “white list” to allow the SIM authentication messages from client to pass through. The pass-through could also be provided through a “Walled garden” service.

The user invokes the client. The client sends MLC-ATTACH-REQUEST identity (tempID/IMSI/MSISDN), NONCE, and optional APN to RAC. The client should always use tempID, unless requested by the network or if the client doesn't have tempID.

If tempID is used, then RAC retrieves IMSI by decrypting the tempID using the Key (Ke) stored at RAC. If the tempID has expired or is otherwise invalid at RAC, then RAC requests Client to send IMSI or MSISDN with an MLC-ATTACH-RESPONSE with “tempID unrecognized.”

RAC responds back with an empty MLC-ATTACH-RESPONSE if tempID decoded correctly and initiates MAP-SEND-AUTHENTICATION-INFO-procedure towards HLR.

If client receives “tempID unrecognized” it should send MLC-ATTACH-REQUEST again with IMSI (or MSISDN) instead of tempID.

If the MAP-SEND-AUTHENTICATION-INFO procedure is successful, then RAC sends MAC_RAND, which is a generated signature using the NONCE sent by the client and the SRES generated by the HLR, a pair of RAND numbers (RAND1, RAND2) retrieved from HLR and “Session id” (a unique number to identify this session with this client) in MLC-AUTH-REQUEST message. On failure, RAC sends MLC-ATTACH-REJECT to the client.

Client runs the GSM algorithm on the SIM using the received RAND numbers and uses the results to verify the received MAC-RAND (to authenticate the network.)

If MAC_RAND is valid, then client sends MLC-AUTH-RESPONSE with MAC_SRES, a signature generated from the RANDs and the SRES generated by the SIM, and Session id, else the client sends MLC-DETACH-INDICATION with Session id to RAC.

RAC checks MAC_SRES, If the User/Client is valid, then RAC initiates MAP-UPDATE-GPRS-LOCATION procedure towards HLR to retrieve the GPRS profile data, else RAC sends MLC-ATTACH-REJECT with optional Reject Message. This Reject message can be displayed to the user.

If the Location Update procedure is successful, then RAC performs APN selection algorithm as specified in “TS 03.60—GPRS Service Description—Stage 2” document. Upon successful completion, RAC sends MLC-ATTACH-ACCEPT to the user with new tempID. The new tempID is something equivalent to Ke (Random Number+IMSI), where Ke is an encryption key known only to the RAC. The password is generated at RAC as well as Client using the authentication credentials, such as a signature of the tempID and the session key generated by the SIM from the RANDs, other such unique combinations that cannot be replayed or generated from the information sent over the connection are evident (See below.) Since the password can be generated using dynamic credentials valid only for that session, the reply attack can be prevented. Upon failure, RAC sends MLC-ATTACH-REJECT to the user.

Client uses the received new tempID and the generated password to perform the RADIUS/DIAMETER authentication.

Client acknowledges the MLC-ATTACH-ACCEPT message with new tempID, by sending MLC-ATTACH-COMPLETE message with Session id. If the new Temp id is same as the old temp Id, then client shall not send the MLC-ATTACH-COMPLETE message.

Upon receiving MLC-ATTACH-ACCEPT, client posts username (tempId@realm) and the Password (Temp password, generated using the authentication credentials) to the PAC/NAS/RLM. NAS sends the Username and Password in ACCESS-REQUEST (RADIUS) message to RAC. RAC verifies the validity of the user. If the user is valid, then RAC sends ACCESS-ACCEPT with following (optional) attributes: Session timeout and idle timeout. If the user is invalid, then RAC sends ACCESS-REJECT message to the NAS and the client access is denied.

Once authentication is successful, the user can then browse the Internet. ACCOUNTING (START) message is sent by NAS and the start time is noted by RAC for CDR.

Interim ACCOUNTING messages are forwarded to RAC. The RAC either updates the accounting information for the user or converts the information into partial CDRs and sends them to the CGF.

Upon explicit logoff or timeout, the NAS forwards the ACCOUNTING (STOP) message to RAC, which then convert it into a CDR and sends to CGF.

NUDP is used as the transport mechanism between RAC and the client. Alternatively, SSL can be used between RAC and the Client, instead of UDP.

Password Generation Procedures

This section briefs on the different ways to generate the password.

One method to generate password is Substring (MD5 (RAND2+IMSI+Kc)), where Kc is a session key generated during the SIM exchange.

Another password generation method is Kc1 (RAND2, MAC_SRES) where RAND2 is a throwaway. This way both sides have everything that is needed for password verification. This introduces randomness in the password and is protected from replay attack. No extra signaling is needed for RAC to issue a password for NAI auth.

Other method could be Kc1 (Kc2) and since same Kc is not used again, the password generated changes every time and is protected from replay attack.

Various PassGen methods could be designed by using the different permutations of the authentication credentials obtained during SIM authentication phase.

Thus is has been shown that the client 140 with software can use a SIM to be authenticated to the operator's HLR while roaming into a WISP hotspot without any modifications to said hotspot. The invention has been explained with reference to specific embodiments. Other embodiments will be evident to those of skill in the art. It is therefore not intended that this invention be limited, except as indicated by the appended claims.

1. A method for performing SIM-based authentication and authorization in a WLAN Internet Service Provider (WISP) network comprising:
supporting a method of authentication according to the universal access method (UAM) of authentication and authorization, in order to enable roaming for customers of mobile service providers onto said networks, substantially as shown and described.

2. A method according to claim 1 further including employing temporary credentials in order to provide secure means for authenticating a client of a customer client device to a network of a mobile service provider for authentication with privacy as to user identity and to prevent replay attacks.

3. An apparatus for performing SIM-based authentication and authorization in a WLAN Internet Service Provider (WISP) network comprising:
a system supporting a method of authentication according to the universal access method (UAM) of authentication and authorization, in order to enable roaming for customers of mobile service providers onto said networks, substantially as shown and described.
